(19) United States
(12) Patent Application Publication
(10) Pub. No.: US 2026/0146587 A1
(43) Pub. Date: May 28, 2026

(54) Wind Power Production Prediction Using Machine Learning Based Image Processing

(71) Applicant: Google LLC, Mountain View, CA (US)

(72) Inventors: Kartik Chaudhary, Bengaluru (IN); Supriya Sharma, Bengaluru (IN)

(21) Appl. No.: 19/121,684

(22) PCT Filed: Jan. 3, 2023
(86) PCT No.: PCT/US2023/060018

§ 371 Date: Apr. 16, 2025

(30) Foreign Application Priority Data
Oct. 31, 2022 (IN) 202221061929

(51) Int. Cl. F03D 17/00; G06V 10/82

(52) U.S. Cl. CPC F03D 17/006; G06V 10/82

(57) ABSTRACT

A method includes determining a power curve image that includes a plurality of pixels that represents power production by a plurality of wind turbines of a wind farm as a function of wind speed. The method also includes determining, by a machine learning (ML) encoder model, a latent representation of attributes of the wind farm based on processing the power curve image by the ML encoder model. The method additionally includes obtaining an expected weather data corresponding to a future time. The method further includes determining, based on the latent representation and the expected weather data, an expected power production by the wind farm at the future time, and generating an output that includes the expected power production.

### CROSS-REFERENCE TO RELATED APPLICATIONS

This application claims priority to Indian Patent Application No. 202221061929, filed on Oct. 31, 2022, and titled “Wind Power Production Prediction Using Machine Learning Based Image Processing,” which is hereby incorporated by reference as if fully set forth in this description.

### BACKGROUND

A wind farm may include a plurality of wind turbines configured to generate electric power. Power generation of the wind farm may vary depending on weather conditions, including wind speed. It is desirable to accurately predict an amount of power that will be generated by a wind farm at a future time.

### SUMMARY

A machine learning (ML) model may be configured to assist with determining an expected future power production of a wind farm. The power curve of the wind farm may represent a power output of the wind farm as a function of wind speed. The power curves of different wind farms may vary depending on various attributes of these wind farms. Accordingly, the power curves may represent these various attributes of the wind farms, some of which might not be directly measurable. The power curve of the wind farm may be converted to an image, and the image may thus represent the attributes of the wind farm as visual patterns. The image may be processed by the ML model to generate a latent representation that is indicative of the attributes of the wind farm. The latent representation may be used along with expected future weather data to determine the expected future power production for the wind farm.

In a first example embodiment, a method may include determining a power curve image that includes a plurality of pixels that represents power production by a plurality of wind turbines of a wind farm as a function of wind speed. The method may also include determining, by an ML encoder model, a latent representation of attributes of the wind farm based on processing the power curve image by the ML encoder model. The method may additionally include obtaining an expected weather data corresponding to a future time. The method may further include determining, based on the latent representation and the expected weather data, an expected power production by the wind farm at the future time. The method may yet further include generating an output that includes the expected power production.

In a second example embodiment, a method may include determining a training power curve image that includes a plurality of pixels that represents power production by a plurality of training wind turbines of a training wind farm as a function of wind speed. The method may also include determining, by a machine learning (ML) encoder model, a training latent representation of attributes of the training wind farm based on processing the training power curve image by the ML encoder model. The method may additionally include determining, by an ML decoder model, a reconstruction of the training power curve image based on processing the training latent representation by the ML decoder model. The method may further include determining a loss value based on comparing (i) the reconstruction of the training power curve image to (ii) the training power curve image. The method may yet further include adjusting one or more parameters of the ML encoder model based on the loss value.

In a third example embodiment, a system may include a processor and a non-transitory computer-readable medium having stored thereon instructions that, when executed by the processor, cause the processor to perform operations in accordance with the first example embodiment and/or the second example embodiment.

In a fourth example embodiment, a non-transitory computer-readable medium may have stored thereon instructions that, when executed by a computing device, cause the computing device to perform operations in accordance with the first example embodiment and/or the second example embodiment.

In a fifth example embodiment, a system may include various means for carrying out each of the operations of the first example embodiment and/or the second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing system, in accordance with examples described herein.

FIG. 2 illustrates a system, in accordance with examples described herein.

FIGS. 3A, 3B, and 3C illustrate wind farm power curves, in accordance with examples described herein.

FIGS. 3D and 3E illustrate images of wind farm power curves, in accordance with examples described herein.

FIG. 4 illustrates a training system, in accordance with examples described herein.

FIG. 5 illustrates a flow chart, in accordance with examples described herein.

FIG. 6 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

A wind farm may include a plurality of wind turbines configured to produce electric power. The amount of power produced by the find farm may depend on weather conditions and attributes (i.e., characteristics) of the wind farm. The attributes of the wind farm may include any physical properties of and/or associated with the wind farm that affect how much power is generated under various weather conditions. While some of these attributes may be directly measurable, others may be difficult and/or impractical to measure. For example, wind farm location, turbine type, turbine blade size, turbine height, and/or turbine diameter may be directly measurable. However, it may be difficult to measure other properties of the wind farm, such as component degradation over time, temperature-dependent performance variations, surroundings of the wind farm (e.g., tall buildings, trees, mountains, etc. that can affect wind and/or other weather properties), variations in the topology of the wind farm causing variations in the height of different wind turbines, and/or efficiency variations of different components of different wind turbines, among others. Properties that are difficult and/or impractical to measure may nevertheless affect how much power the wind farm produces under various weather conditions, and may thus be important to quantify.

The amount of power produced by the wind farm may be a function of wind speed. Specifically, each wind turbine may start producing power when the wind speed exceeds a corresponding cut-in speed, and may produce its maximum rated power at wind speeds greater than or equal to a corresponding rated output speed. When the output power of the wind turbine is graphed (e.g., on a vertical axis) as a function of wind speed (e.g., on a horizontal axis), the resulting power curve may be approximately S-shaped. The power curve for the wind farm may depend on the corresponding power curves of the plurality of wind turbines that make up the wind farm. Thus, the power curve for the wind farm may vary from the (theoretical/idealized) S-shape, with the variation being based on the collective attributes of the wind turbines that make up the wind farm.

To more accurately predict how much power a wind farm will produce, the attributes of the wind farm may be determined by processing the power curve of the wind farm by an ML encoder model. Specifically, a power curve image may be generated based on the power curve of the wind farm. The power curve image may include a plurality of pixels that provide a visual representation of a plurality of samples that make up the power curve. The ML encoder model may be configured to process the power curve image and, based on this processing, generate a latent representation that provides an indication of the attributes of the wind farm. Thus, ML-based image processing techniques may be used to extract, from an image of a power curve for a wind farm, attributes of the wind farm. The attributes of the wind farm represented by the latent representation may include the attributes that are directly measurable and/or the attributes that may be difficult and/or impractical to measure.

A power prediction ML model may be configured to process the latent representation of the wind farm, along with expected weather data corresponding to a future time, to determine an expected power production by the wind farm at the future time. The power prediction ML model may be configured, as a result of training, to determine how variations in the expected weather interact with attributes of the wind farm to cause variations in power production. The expected power production of the wind farm may be used to determine how to distribute the power generated by the wind farm, and/or how much additional power is to be generated by other power sources to reach a target power production for the future time.

The power curve image may be generated based on a normalized version of the power curve for the wind farm. The number of samples used to define the power curve may be exactly, substantially, and/or approximately equal to a number of training samples used in generating each training image using which the ML encoder model has been trained. Further, the vertical scale representing power output may be expressed as a fraction of maximum output power, rather than as absolute power, so that different wind turbines and/or wind farms having different absolute maximum power outputs may be directly comparable along a shared relative power output scale. The horizontal scale representing wind speed may range from a predetermined minimum wind speed to a predetermined maximum wind speed, with sample values falling below the minimum wind speed and/or above the maximum wind speed being excluded from defining the power curve.

Using a constant and/or fixed number of samples plotted along graphs of constant and/or fixed area to generate power curve images in both inference and training may allow each power curve image to contain a substantially and/or approximately equal visual density of information, thus allowing the ML encoder model to be used to map visual patterns in power curve images to latent representations of attributes of wind farms. Thus, latent representations generated by the ML encoder model may more accurately represent wind farm attributes when the power curve images input into the ML encoder are generated using a consistent and/or standardized process. On the contrary, if the power curve images were generated based on varying numbers of samples plotted along axes of varying scales, the appearance of a given power curve image for a corresponding wind farm would vary, which might hinder the ability of the ML encoder model to learn to reliably extract wind farm attributes from visual patterns in the power curve images.

Additionally, the power curve image may be converted to a grayscale image, if not already expressed in grayscale, to reduce and/or eliminate the effect of color on representing the attributes of the wind farm. In some implementations, the power curve image may initially be generated at full resolution, and may be subsequently down sampled prior to processing by the ML encoder model, which may (i) allow for reduced complexity and/or size of the ML encoder model and (ii) reduce the effect of high-frequency outliers (which may represent noise and/or errors in the data) on the resulting latent representations. In some cases, prior to processing the down-sampled version of the power curve image by the ML encoder model, the down-sampled version of the power curve image may be filtered using one or more operators (e.g., erosion and/or dilation) to further reduce the number of outlier samples represented by the down-sampled power curve image.

Generating the latent representation of attributes of the wind farm based on power curve images, rather than based directly on the samples that make up the power curves, may be more accurate and/or more efficient. Specifically, generating the power curve image may operate to filter out noise and/or outlier data, since noise and/or outliers might generate little to no visual pattern in the power curve images. Further, a power curve image having H×W pixels may be based on a number of samples that is much greater than H×W. Thus, a number of parameters involved in defining the ML encoder model to accurately process the H×W pixels may be smaller than a number of parameters involved in defining a version of the ML encoder model to process the raw samples. A smaller model may be faster to train and execute, and may thus utilize less energy and/or fewer computing resources.

### II. Example Computing System

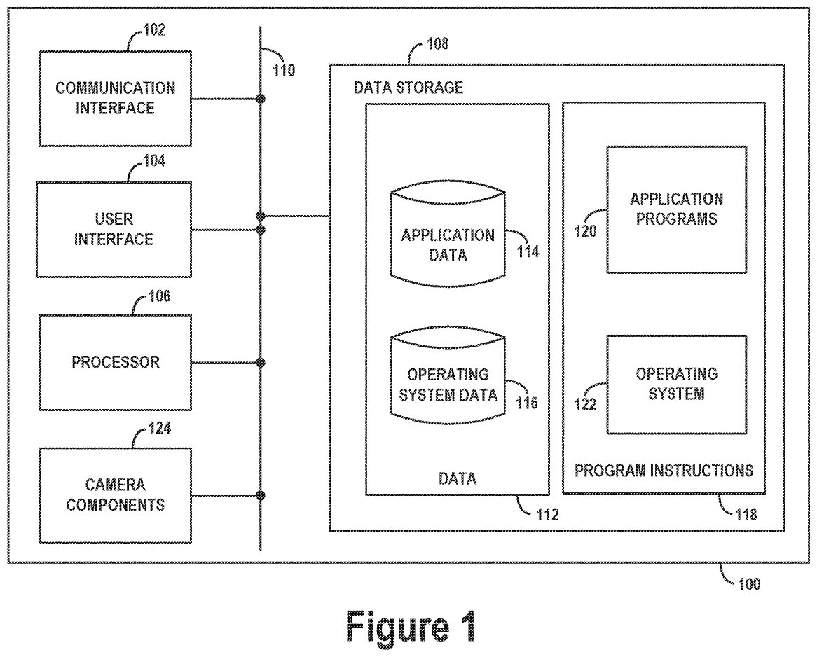

FIG. 1 is a simplified block diagram showing some of the components of an example computing system 100. By way of example and without limitation, computing system 100 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device.

As shown in FIG. 1, computing system 100 may include communication interface 102, user interface 104, processor 106, data storage 108, and camera components 124, all of which may be communicatively linked together by a system bus, network, or other connection mechanism 110. Computing system 100 may be equipped with at least some image capture and/or image processing capabilities. It should be understood that computing system 100 may represent a physical image processing system, a particular physical hardware platform on which an image sensing and/or processing application operates in software, or other combinations of hardware and software that are configured to carry out image capture and/or processing functions.

Communication interface 102 may allow computing system 100 to communicate, using analog or digital modulation, with other devices, access networks, and/or transport networks. Thus, communication interface 102 may facilitate circuit-switched and/or packet-switched communication, such as plain old telephone service (POTS) communication and/or Internet protocol (IP) or other packetized communication. For instance, communication interface 102 may include a chipset and antenna arranged for wireless communication with a radio access network or an access point. Also, communication interface 102 may take the form of or include a wireline interface, such as an Ethernet, Universal Serial Bus (USB), or High-Definition Multimedia Interface (HDMI) port, among other possibilities. Communication interface 102 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 102. Furthermore, communication interface 102 may comprise multiple physical communication interfaces (e.g., a Wi-Fi interface, a BLUETOOTH® interface, and a wide-area wireless interface).

User interface 104 may function to allow computing system 100 to interact with a human or non-human user, such as to receive input from a user and to provide output to the user. Thus, user interface 104 may include input components such as a keypad, keyboard, touch-sensitive panel, computer mouse, trackball, joystick, microphone, and so on. User interface 104 may also include one or more output components such as a display screen, which, for example, may be combined with a touch-sensitive panel. The display screen may be based on CRT, LCD, LED, and/or OLED technologies, or other technologies now known or later developed. User interface 104 may also be configured to generate audible output(s), via a speaker, speaker jack, audio output port, audio output device, earphones, and/or other similar devices. User interface 104 may also be configured to receive and/or capture audible utterance(s), noise(s), and/or signal(s) by way of a microphone and/or other similar devices.

In some examples, user interface 104 may include a display that serves as a viewfinder for still camera and/or video camera functions supported by computing system 100. Additionally, user interface 104 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 106 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 108 may include one or more volatile and/or non-volatile storage components, such as magnetic, optical, flash, or organic storage, and may be integrated in whole or in part with processor 106. Data storage 108 may include removable and/or non-removable components.

Processor 106 may be capable of executing program instructions 118 (e.g., compiled or non-compiled program logic and/or machine code) stored in data storage 108 to carry out the various functions described herein. Therefore, data storage 108 may include a non-transitory computer-readable medium, having stored thereon program instructions that, upon execution by computing system 100, cause computing system 100 to carry out any of the methods, processes, or operations disclosed in this specification and/or the accompanying drawings. The execution of program instructions 118 by processor 106 may result in processor 106 using data 112.

By way of example, program instructions 118 may include an operating system 122 (e.g., an operating system kernel, device driver(s), and/or other modules) and one or more application programs 120 (e.g., camera functions, address book, email, web browsing, social networking, audio-to-text functions, text translation functions, and/or gaming applications) installed on computing system 100. Similarly, data 112 may include operating system data 116 and application data 114. Operating system data 116 may be accessible primarily to operating system 122, and application data 114 may be accessible primarily to one or more of application programs 120. Application data 114 may be arranged in a file system that is visible to or hidden from a user of computing system 100.

Application programs 120 may communicate with operating system 122 through one or more application programming interfaces (APIs). These APIs may facilitate, for instance, application programs 120 reading and/or writing application data 114, transmitting or receiving information via communication interface 102, receiving and/or displaying information on user interface 104, and so on.

In some cases, application programs 120 may be referred to as “apps” for short. Additionally, application programs 120 may be downloadable to computing system 100 through one or more online application stores or application markets. However, application programs can also be installed on computing system 100 in other ways, such as via a web browser or through a physical interface (e.g., a USB port) on computing system 100.

Camera components 124 may include, but are not limited to, an aperture, shutter, recording surface (e.g., photographic film and/or an image sensor), lens, shutter button, infrared projectors, and/or visible-light projectors. Camera components 124 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 124 may be controlled at least in part by software executed by processor 106.

### III. Example Wind Farm Power Production Prediction System

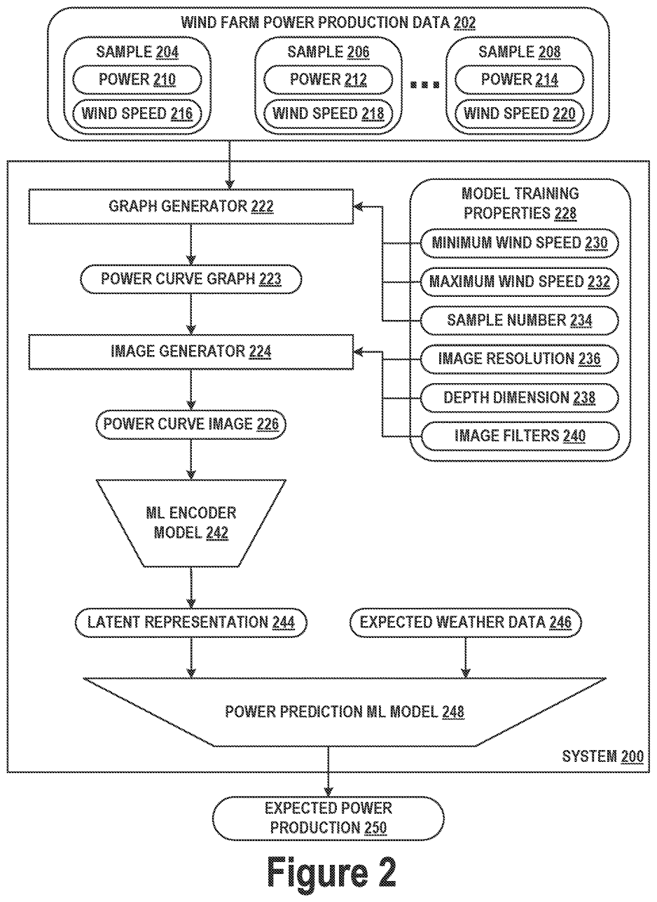

FIG. 2 illustrates an example system for determining an expected power production for a wind farm based on expected weather data and historic power production of the wind farm. Specifically, system 200 may be configured to generate expected power production 250 based on expected weather data 246 and wind farm power production data 202. System 200 may include graph generator 222, image generator 224, ML encoder model 242, and power prediction ML model 248.

Graph generator 222 may be configured to generate power curve graph 223 based on wind farm power production data 202 and model training properties 228. Image generator 224 may be configured to generate power curve image 226 based on power curve graph 223 and model training properties 228. Power curve image 226 may include a plurality of pixels that provide a visual representation of power curve graph 223. ML encoder model 242 may be configured to generate latent representation 244 based on power curve image 226. Power prediction ML model 248 may be configured to generate expected power production 250 based on latent representation 244 and expected weather data 246. That is, system 200 may be configured to convert wind farm power production data 202 into an image and process the image using ML models to determine an expected power production of the wind farm at a future time.

Wind farm power production data 202 may represent historic power production of a wind farm as a function of wind speed. Wind farm power production data 202 may include sample 204 and sample 206 through sample 208 (i.e., samples 204-208). Each of samples 204-208 may indicate a corresponding power output of the wind farm associated with (e.g., caused by) a corresponding wind speed during a corresponding time interval. For example, sample 204 may indicate that, during a first time interval, wind speed 216 caused the wind farm to generate power 210. Sample 206 may indicate that, during a second time interval, wind speed 218 caused the wind farm to generate power 212. Sample 208 may indicate that, during a third time interval, wind speed 220 caused the wind farm to generate power 214. The corresponding power and wind speed values of each of samples 204-208 may represent, for example, an average, a minimum, and/or a maximum value observed during the corresponding time interval. Alternatively, each of samples 204-208 may represent a time point rather than a time interval, and the corresponding power and wind speed values thereof may thus represent instantaneous values.

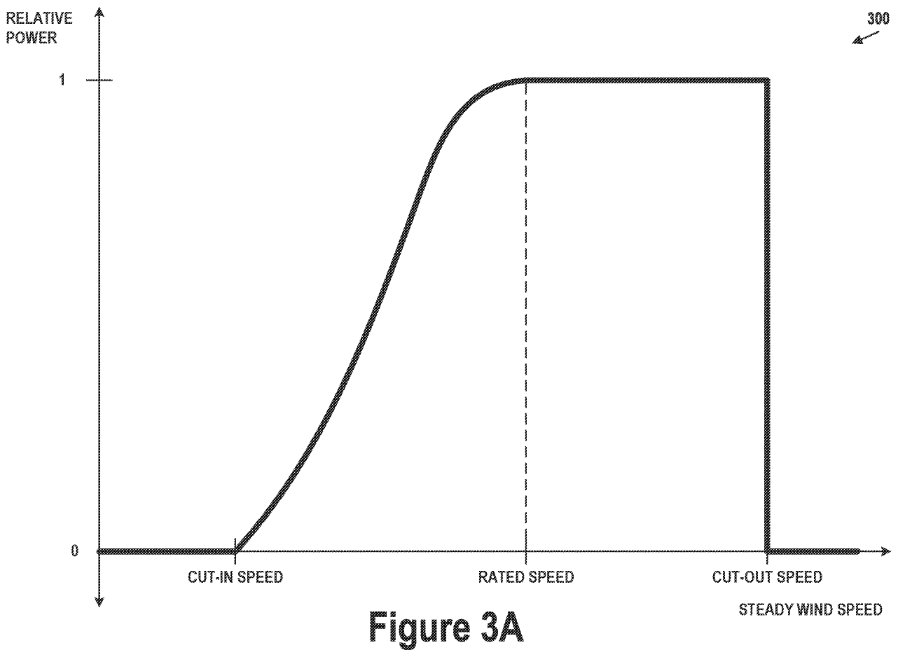

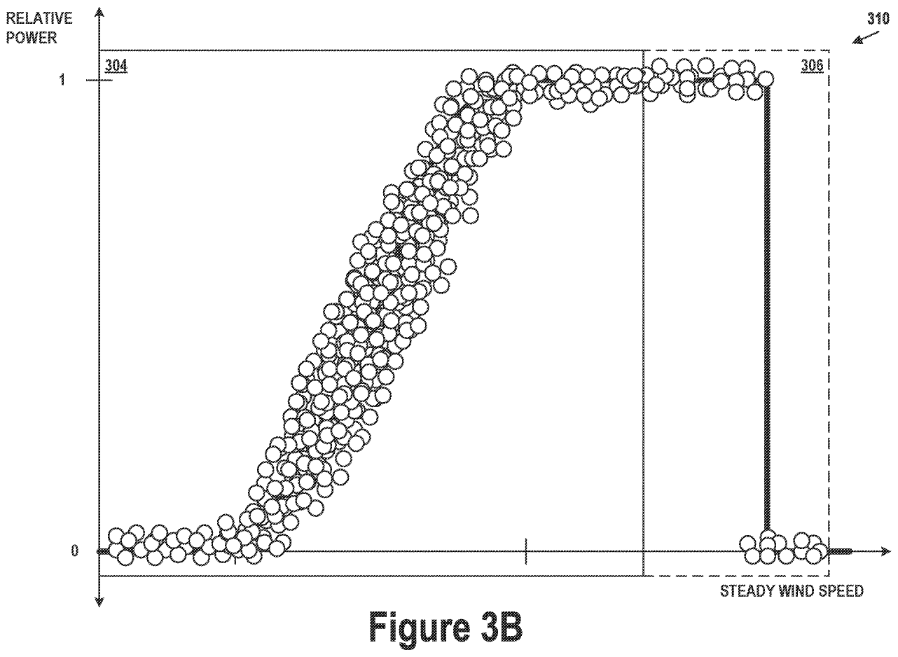

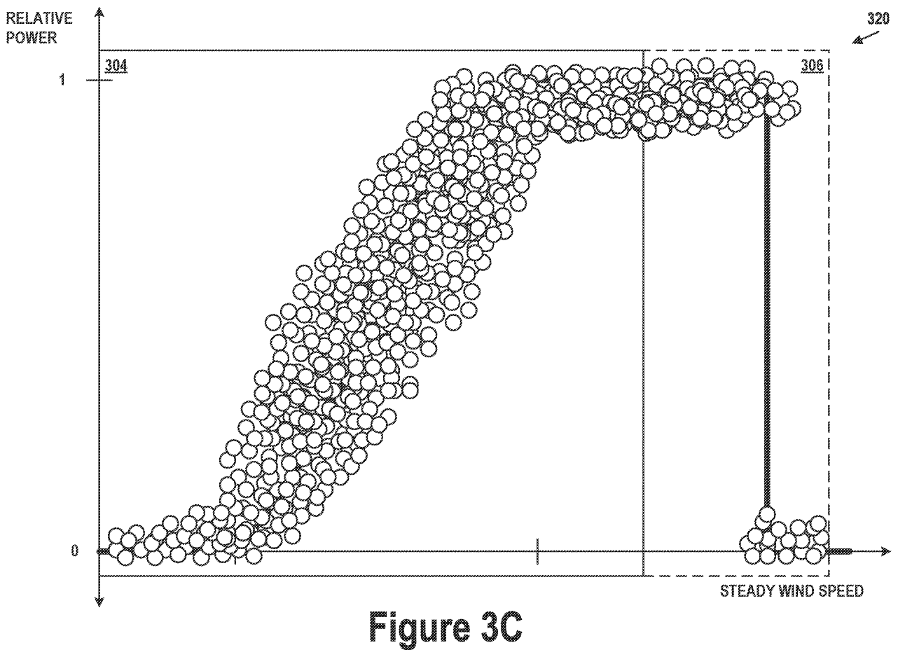

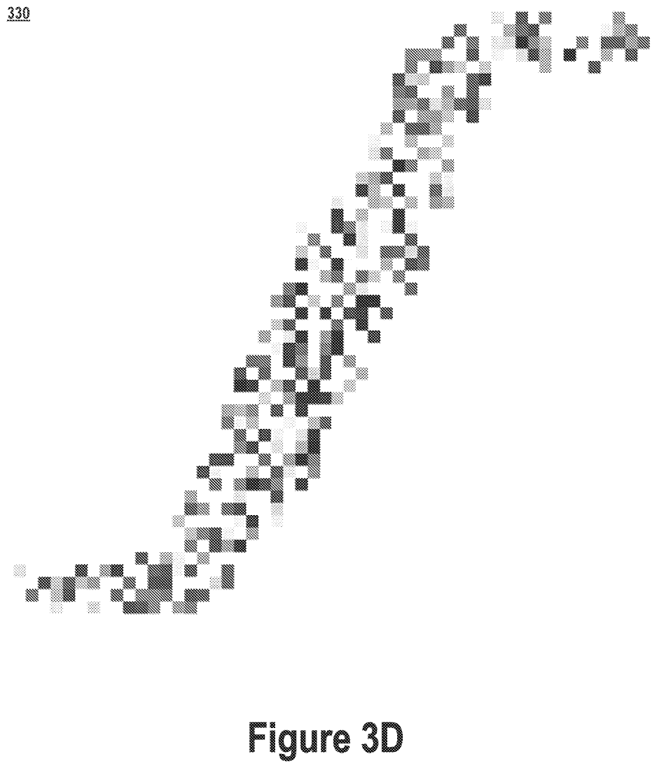

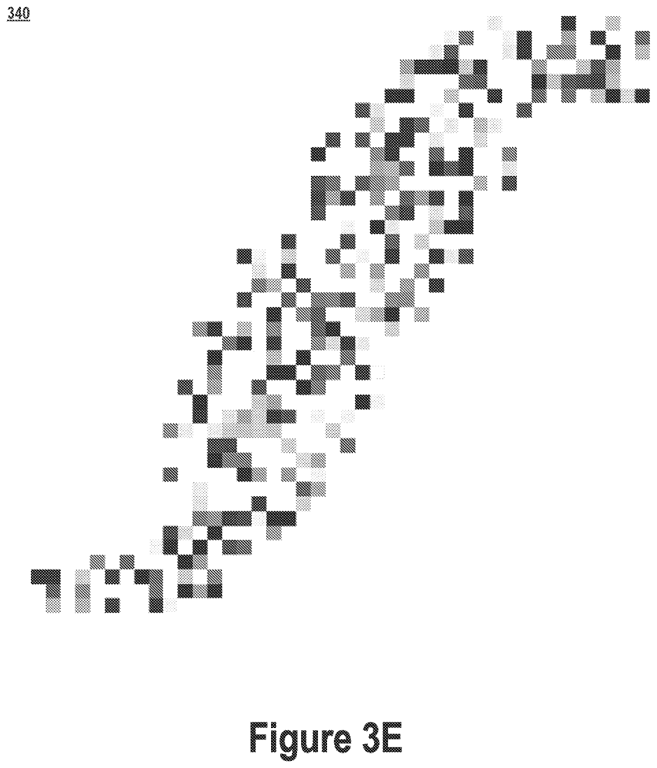

When power (e.g., power values 210-214) is graphed as a function of wind speed (e.g., wind speed values 216-220), the wind farm power production data of a given wind farm may resemble and/or generally track an approximately S-shaped curve, as illustrated by graph 300 shown in FIG. 3A. Specifically, graph 300 illustrates a theoretical and/or idealized relationship between steady wind speed, as shown along the horizontal axis, and relative power, as shown along the vertical axis. Relative power may be determined by dividing a measured power output of the wind farm by a rated (i.e., maximum) power output of the wind farm, with a value of 1 representing a wind farm operating at or near peak capacity. The wind farm may begin generating power when the steady wind speed meets and/or starts to exceed a cut-in speed, may generate increasingly more power as the steady wind speed increases from the cut-in speed to a rated speed, may generate peak relative power when the steady wind speed is between a rated speed and cut-out speed, and may cease generating power when the steady wind speed exceeds the cut-out speed.

The relative power generated by a given farm at different wind speeds may be based on the wind turbines that make up the wind farm. Each turbine of a wind farm may be associated with various attributes that affect how much relative power the wind turbine generates at different wind speeds. For example, the attributes may include physical properties of the wind turbine, aspects of the wind turbine's installation, and/or aging/wear-and-tear on the wind turbine, among other properties. Accordingly, the relative power generated by the wind farm at different wind speeds may be determined collectively by the attributes of the individual wind turbines that make up the wind farm. Thus, in practice, the actual shape of the power curve for a wind farm may vary and/or deviate from the idealized/theoretical version shown in graph 300.

For example, FIG. 3B includes graph 310 that illustrates an empirically determined (i.e., measured) relationship between steady wind speed and relative power for a first example wind farm. FIG. 3C includes graph 320 that illustrates an empirically determined relationship between steady wind speed and relative power for a second example wind farm different from the first example wind farm. Graphs 310 and 320 provide examples of power curve graph 223. Both graph 310 and graph 320 include the same area and the same number of samples plotted thereon. The samples in graph 310 more closely track the idealized/theoretical S-shaped power curve (as shown in graph 300) than the samples in graph 320. Specifically, the samples in graph 320 have a greater spread and/or variability around the idealized/theoretical power curve than the samples in graph 310.

Such variations and/or deviations from the idealized/theoretical power curve may be caused by the specific attributes of the wind farm. Accordingly, these variations and/or deviations may indirectly represent the specific attributes of the wind farm. That is, the specific shape and/or pattern of the power curve of a particular wind farm may be indicative of the corresponding attributes of the particular wind farm, and the corresponding attributes of the particular wind farm may be defined collectively by the attributes of individual wind turbines that make up the particular wind farm. Accordingly, graph 310 may be used to determine the attributes of the first wind farm, and graph 320 may be used to determine the attributes of the second wind farm.

Turning back to FIG. 2, ML encoder model 242 may be trained to determine the attributes of the wind farm based on a power curve image that represents a measured relationship between relative power and wind speed for the wind farm. Accordingly, graph generator 222 may be configured to generate power curve graph 223 by selecting, from samples 204-208, a plurality of samples. Image generator 224 may be configured to generate power curve image 226 by generating a plurality of pixels that represent power curve graph 223. Power curve graph 223 and power curve image 226 may be generated based on model training properties 228, which may indicate a normalized and/or standardized process for generating graphs and images during training and inference involving ML encoder model 242.

Model training properties 228 may indicate a manner in which training power curve images were generated as part of training of ML encoder model 242, and accurate performance at inference may depend on generating power curve image 226 in the same or similar manner. Specifically, since power curve graph 223 is converted to power curve image 226, which is then processed by ML encoder model 242 to determine latent representation 244 of the attributes of the wind farm, the attributes of the wind farm are represented by power curve image 226 as visual patterns. In order for a given visual pattern of a power curve image to reliably represent the same attribute of the wind farm across training and inference, and thus be usable to determine an expected power production for the wind farm, the power curve images may be generated in a consistent (i.e., same or similar) manner during iterations of training and inference. Such consistency may prevent and/or reduce the likelihood of graph generator 222 and/or image generator 224 introducing into power curve image 226 a (false positive) visual pattern resulting from a deviation from the normalized and/or standardized image generation process, rather than resulting from a (true positive) structure of wind farm power production data 202.

Model training properties 228 may include minimum wind speed 230, maximum wind speed 232, sample number 234, image resolution 236, depth dimension 238, and image filters 240. Minimum wind speed 230 may define a lower bound of the horizontal axis (that represents steady wind speed) of power curve graph 223, while maximum wind speed 232 may define an upper bound of the horizontal axis of power curve graph 223. Thus, minimum wind speed 230 and maximum wind speed 232 may collectively define a steady wind speed range based on which graph generator 222 is to select samples from samples 204-208. Accordingly, graph generator 222 may be configured to select, from samples 204-208, samples associated with wind speeds that are greater than or equal to minimum wind speed 230 and less than or equal to maximum wind speed 232.

In cases where samples 204-208 represent power 210-214 using absolute power values (e.g., expressed in Watts), rather than relative power values (e.g., expressed as a fraction of peak power production), graph generator 222 may be configured to convert any absolute power values into corresponding relative power values. Specifically, graph generator 222 may be configured to convert a particular absolute power value of the wind farm into a corresponding relative power value by dividing the absolute power value by a peak capacity (i.e., a maximum capacity or rated capacity) of the wind farm. Thus, since the vertical axis (that represents relative power) may have a range of 0 to 1 (or 0% to 100%, when expressed as a percentage), the range thereof may be constant across different wind farms. Accordingly, minimum wind speed 230 and maximum wind speed 232 (along with the fixed vertical axis) may collectively define an area of power curve graph 223.

Sample number 234 may indicate a number of samples to be selected from samples 204-208 and plotted to generate power curve graph 223. Thus, for given values of minimum wind speed 230 and maximum wind speed 232, sample number 234 may indicate an average sample density (i.e., samples per unit area) for power curve graph 223. If the number of samples used to generate power curve images was varied by more than a threshold amount relative to sample number 234, different visual patterns might be introduced into power curve image 226 by the resulting (false positive) variable sample density, thereby reducing the ability of ML encoder model 242 to accurately extract attributes of the wind farm from the resulting power curve images.

Image resolution 236 may indicate a number and/or arrangement of pixels used to express power curve graph 223 as an image. Depth dimension 238 may indicate a number of values per pixel that are used to express power curve graph 223 as an image. Power curve image 226 may be represented as an H×W×D tensor, where H, W, and D represent a height, width, and depth, respectively, of power curve image 226. Image resolution 236 may define a value of H and W, and depth dimension 238 may define a value of D. The values of H, W, and D may be constant across training and inference because ML encoder model 242 may be structured to process images of constant size. For example, image resolution 236 may indicate that H and W each have a value of 1024, and depth dimension 238 may indicate that D has a value of 4 (i.e., four depth values per pixel).

In some implementations, power curve image 226 may include one depth layer. Thus, power curve image 226 may be interpreted as a grayscale image (or other monochromatic image). In other implementations, power curve image 226 may include two or more depth layers, and may thus be interpreted as a color image. When two or more depth layers are used to generate power curve image 226, each respective depth layer of the two or more depth layers may represent samples corresponding to a different subset of samples 204-208. For example, each respective depth layer may represent samples from a corresponding time period and/or samples from a corresponding group of wind turbines, among other possible partitions of samples 204-208. Thus, power curve image 226 may encode at least some information about the attributes of the wind farm using the manner in which samples 204-208 are partitioned among depth layers of power curve image 226. In cases where power curve graph 223 is represented using different colors, and the colors merely represent visual appearance but do not encode attributes of the wind farm (i.e., do not represent an intentional partition of samples 204-208), a color version of power curve image 226 may be converted into a grayscale version of power curve image 226.

Image filters 240 may indicate properties of one or more image filters to be used in generating power curve image 226. For example, image filters 240 may define a dilation operator, an erosion operator, a difference of Gaussian operators, and/or other image filters used when generating training power curve images. Image filters 240 may be configured to reduce an effect of noise and/or outlier samples on power curve image 226, and thus on latent representation 244 and expected power production 250.

FIGS. 3B and 3C illustrate two different example values of maximum wind speed 232. Specifically, area 304 indicates one possible region of graphs 310 and/or 320 to be represented by pixels of power curve image 226. Additional area 306 indicates an additional region of graphs 310 and/or 320 that could also be represented by pixels of power curve image 226. Thus, power curve image 226 may represent the visual contents of area 304, or the visual contents of the union of areas 304 and 306. Area 304 corresponds to a maximum wind speed 232 above the rated speed and below the cut-out speed, while the union of area 304 and additional area 306 corresponds to a maximum wind speed 232 above the cut-out wind speed.

In some cases, the additional visual information provided in additional area 306 (or another additional area of a different size) may substantially improve the accuracy with which latent representation 244 represents the attributes of the wind farm, and both area 304 and additional area 306 may thus be included in power curve image 226. In other cases, the additional visual information provided in additional area 306 (or another additional area of a different size) might not substantially improve the accuracy with which latent representation 244 represents the attributes of the wind farm, and area 304 may be included in power curve image 226 while additional area 306 might be excluded from power curve image 226. In some implementations, the determination of whether to include or exclude additional area 306 (i.e., the selection of maximum wind speed 232) from power curve image 226 may be based on wind speeds expected at inference time.

FIG. 3D illustrates an example power curve image 330 generated by image generator 224 based on power curve graph 310. FIG. 3E illustrates an example power curve image 340 generated by image generator 224 based on power curve graph 320. Each of power curve images 330 and 340 corresponds to area 304 of power curve graphs 310 and 320, respectively. Power curve images 330 and 340 may each represent down-sampled versions of full-resolution images that may be initially generated based on graphs 310 and 320, respectively. The down sampling of full-resolution power curve images may be performed to obtain power curve images having image resolution 236. The pixelated appearance of power curve images 330 and 340 may be an intentional consequence of the down sampling. That is, power curve images 330 and 340 may represent a high-level (i.e., low frequency) structure of the underlying samples, while omitting representation of low-level (i.e., high frequency) details that might not meaningfully encode attributes of the wind farm.

Turning back to FIG. 2, ML encoder model 242 may be configured to generate latent representation 244 based on power curve image 226. Latent representation 244 may indicate one or more attributes of the wind farm, and may thus indicate how the wind farm's power production is expected to vary under different weather conditions. Latent representation 244 may be a tensor having a size that is smaller than a size of power curve image 226, and may thus provide a compressed representation of power curve image 226. Latent representation 244 may alternatively be referred to as an embedding. Latent representation 244 may be and/or include, for example, a two-dimensional vector, a two dimensional-matrix, or a three-dimensional tensor, among other possibilities.

Determining latent representation 244 based on power curve image 226, rather than based directly on the samples used to generate power curve image 226, may reduce a likelihood of ML encoder model 242 overfitting to the training data and thus generating erroneous results at inference. Additionally, determining latent representation 244 based on power curve image 226, may allow ML encoder model 242 to more easily determine the attributes of the windfarm because the process of converting samples 204-208 into an image may reduce and/or minimize the amount of outliers and/or noise present in power curve image 226 and provided as input to ML encoder model 242. Further, a number of pixels in power curve image 226 may be smaller than a number of samples used in generating power curve image 226. Thus, a number of parameters of ML encoder model 242 may be smaller than a number of parameters of an ML model that would be involved in processing the samples directly. Thus, execution and training of ML encoder model 242 may utilize less power and/or computing resources (e.g., memory and processor cycles), while generating more accurate results.

Power prediction ML model 248 may be configured to generate expected power production 250 based on latent representation 244 and expected weather data 246. Expected weather data 246 may represent expected weather at a future time, and thus expected power production 250 may correspond to the future time. The future time may be several minutes, hours, or days into the future. Specifically, power prediction ML model 248 may be configured to determine how the wind farm, given its attributes as represented by latent representation 244, is expected to perform under weather conditions represented by expected weather data 246. Expected weather data 246 may include an expected measure of wind speed, precipitation, visibility, solar radiation, pressure, humidity, and/or visibility, among other possibilities.

Expected power production 250 may be stored in memory, transmitted to one or more computing devices, displayed using one or more user interfaces, and/or used to make one or more determinations related to distribution of power from the wind farm. In one example, expected power production 250 may be used to determine how much power is to be produced at the future time by alternative sources of energy (e.g., solar power, fossil fuel-based power, nuclear power, etc.) to reach a target power production for the future time. In another example, expected power production 250 may be used to determine where to route power generated by the wind farm at the future time based on, for example, a distribution of expected power usage and/or expected power generation by other power sources. Such determinations may be made automatically by one or more models and/or algorithms, and/or manually by one or more individuals involved in maintaining a power grid and/or the distribution of power along the power grid.

### IV. Example Training System

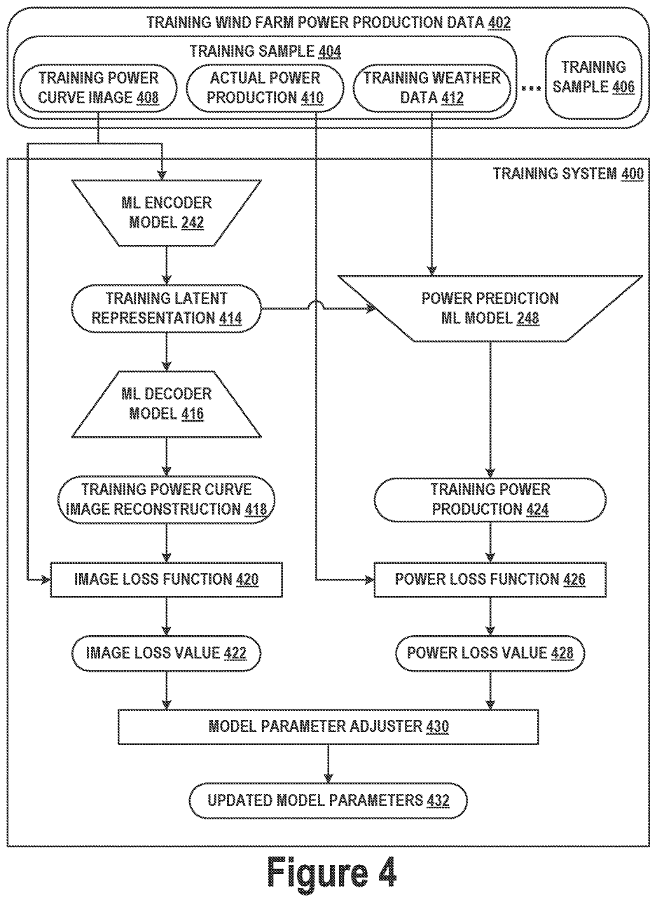

FIG. 4 illustrates an example training system 400 that may be used to train ML encoder model 242 and/or power prediction ML model 248. Training system 400 may include ML encoder model 242, ML decoder model 416, power prediction ML model 248, image loss function 420, power loss function 426, and model parameter adjuster 430. Training system 400 may be configured to generate trained versions of ML encoder model 242 and/or power prediction ML model 248 based on training wind farm power production data 402. ML decoder model 416 may be used during training, but might not be used at inference, and may thus be discarded following training.

Training wind farm power production data 402 may include training samples 404 through 406 (i.e., training samples 404-406). Training wind farm power production data 402 may be obtained from one or more training wind farms (e.g., from a plurality of different training wind farms). Each respective training sample of training samples 404-406 may include a corresponding training power curve image, corresponding training weather data, and corresponding training power production observed under weather conditions represented by the corresponding training weather data. Thus, for example, training sample 404 may include training power curve image 408, training weather data 412, and actual power production 410. Training weather data 412 and actual power production 410 may each include a plurality of data points that span a plurality of time points and/or time intervals.

Training wind farm power production data 402 may be generated by one or more training wind farms that may differ from the wind farm for which expected power production 250 is generated by system 200 at inference time. Thus, learning performed with respect to the one or more training wind farms may be transferred to one or more different wind farms without additional wind farm-specific training. By training ML encoder model 416 to be usable with respect to multiple different wind farms, rather than to be specific to a particular wind farm, ML model 416 may be used to determine expected power production for relatively new wind farms for which sufficient farm-specific training data might not be available. Additionally, using a single ML encoder model for multiple different wind farms simplifies model maintenance and uses fewer computing resources, since one model may be easier to maintain than multiple different farm-specific models.

Training power curve image 408 may be generated in a similar manner as power curve image 226. Specifically, training power curve image 408 may be generated based on a corresponding training power curve graph, and the corresponding training power curve graph may be generated by selecting a plurality of training samples representing measured power outputs of the training wind farm at a plurality of different wind speeds. Unlike power curve image 226, training power curve image 408 may be generated at training time rather than at inference time. Training power curve image 408 may be normalized and/or standardized in the same manner as power curve image 226 based on model training properties 228. Specifically, the manner in which training power curve image 408 is generated may define model training properties 228. Thus, model training properties 228 may be redefined by (i) modifying the manner in which training power curve image 408 is generated and (ii) retraining ML encoder model 416 accordingly.

ML encoder model 242 may be configured to generate training latent representation 414 based on training power curve image 408. Training latent representation 414 may be analogous to latent representation 244, but may be generated as part of training rather than as part of inference. Thus, training latent representation 414 may represent the attributes of the training wind farm associated with training power curve image 408, and the accuracy with which training latent representation 414 represents the attributes of this training wind farm may increase over the course of training.

ML decoder model 416 may be configured to generate training power curve image reconstruction 418 based on training latent representation 414. Training power curve image reconstruction 418 may be a reconstruction of training power curve image 408, and the accuracy with which training power curve image reconstruction 418 matches training power curve image 408 may increase over the course of training. Thus, ML encoder model 242 and ML decoder model 416 may be trained using a self-supervised autoencoding arrangement tasked with reconstructing training power curve image 408 based on a latent representation thereof.

Image loss function 420 may be configured to generate image loss value 422 based on a comparison of training power curve image reconstruction 418 and training power curve image 408. For example, image loss function 420 may include a mean squared error between pixels of training power curve image 408 and pixels of training power curve image reconstruction 418. Thus, image loss value 422 may be indicative of how well ML decoder model 416 is able to reconstruct training power curve image 408 based on training latent representation 414 generated by ML encoder model 242.

Power prediction ML model 248 may be configured to generate training power production 424 based on training weather data 412 and training latent representation 414. Thus, training power production 424 may represent the expected power production of the training wind farm associated with training power curve image 408, given the attributes thereof as represented by training latent representation 414, under weather conditions specified by training weather data 412, and the accuracy of training power production 424 may increase over the course of training.

Power loss function 426 may be configured to generate power loss value 428 based on a comparison of training power production 424 and actual power production 410. For example, power loss function 426 may include an L1-norm and/or an L2-norm difference between training power production 424 and actual power production 410. Thus, power loss value 428 may quantify an accuracy with which power prediction ML model 248 predicts power production of the training wind farm under various weather conditions.

Model parameter adjuster 430 may be configured to determine updated model parameters 432 based on image loss value 422 and/or power loss value 428. Specifically, updated model parameters 432 may be determined such that, during subsequent training iterations, image loss value 422 and/or power loss value 428 is expected to decrease, thus increasing an accuracy of training power curve image reconstruction 418 and/or training power production 424, respectively. Updated model parameters 432 may include one or more updated parameters of any trainable component of ML encoder model 242, ML decoder model 416, and/or power prediction ML model 248.

Model parameter adjuster 430 may be configured to determine updated model parameters 432 by, for example, determining a gradient of image loss function 420 and/or power loss function 426. Based on this gradient and image loss value 422 and/or power loss value 428, model parameter adjuster 430 may be configured to select updated model parameters 432 that are expected to reduce image loss value 422 and/or power loss value 428, and thus improve a performance of ML encoder model 242, ML decoder model 416, and/or power prediction ML model 248. After applying updated model parameters 432 to ML encoder model 242, ML decoder model 416, and/or power prediction ML model 248, the operations discussed above may be repeated to compute another instance of image loss value 422 and/or power loss value 428 and, based thereon, another instance of updated model parameters 432 may be determined and applied to ML encoder model 242, ML decoder model 416, and/or power prediction ML model 248 to further improve the performance thereof. Such training of ML encoder model 242, ML decoder model 416, and/or power prediction ML model 248 may be repeated until, for example, image loss value 422 and/or power loss value 428 is reduced to below a target loss value.

In some implementations, ML encoder model 242, ML decoder model 416, and/or power prediction ML model 248 may be trained jointly. That is, at each training iterations, parameters of any one of ML encoder model 242, ML decoder model 416, and power prediction ML model 248 may be adjustable. Accordingly, ML encoder model 242 may learn to generate latent representation that are useful for both (i) training power curve image reconstruction and (ii) power prediction.

In other implementations, ML encoder model 242 and ML decoder model 416 may be trained independently of power prediction ML model 248. For example, ML encoder model 242 and ML decoder model 416 may be pretrained using image loss function 420. Once the pretraining of ML encoder model 242 and ML decoder model 416 is completed, power prediction ML model 248 may be trained using power loss function 426 while parameters of ML encoder model 242 and ML decoder model 416 are held fixed (i.e., locked or frozen). Accordingly, power prediction ML model 248 may learn to interpret latent representation generated by ML encoder model 242 for power prediction.

### V. Additional Example Operations

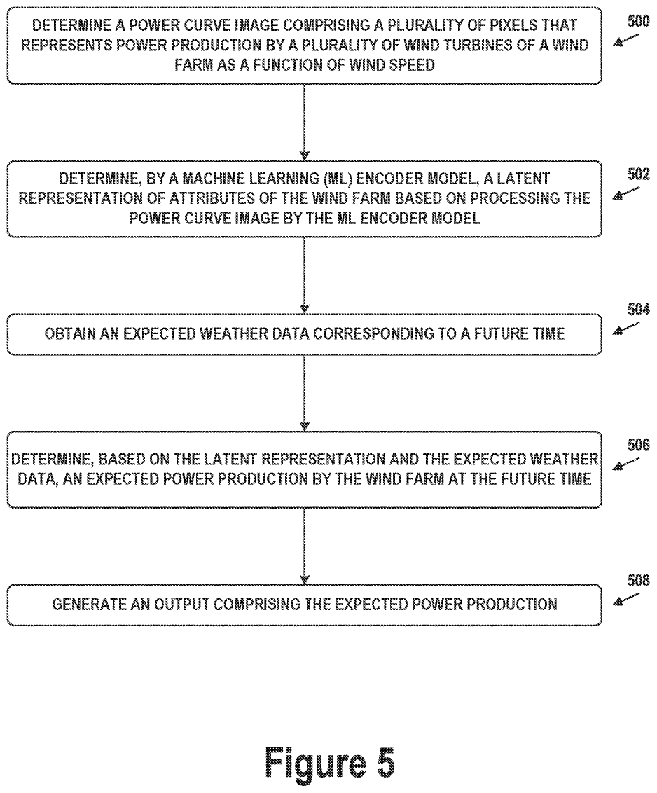

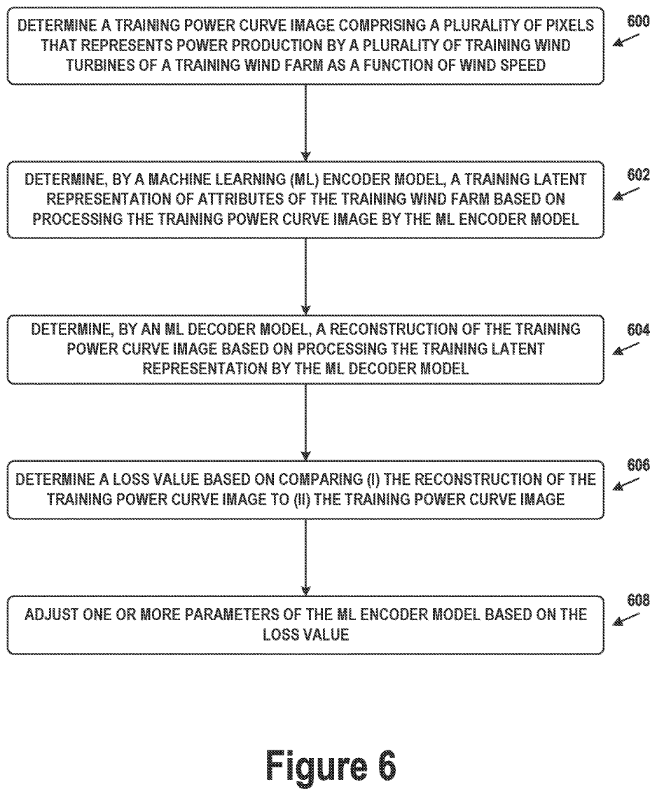

FIG. 5 illustrates a flow chart of operations related to predicting power production of a wind farm based on a power curve image associated with the wind farm. FIG. 6 illustrates a flow chart of operations related to training ML models to predict power production of wind farms. The operations of FIG. 5 and/or FIG. 6 may be carried out by computing system 100, system 200, and/or training system 400, among other possibilities. The embodiments of FIG. 5 and/or FIG. 6 may be simplified by the removal of any one or more of the features shown therein. Further, these embodiments may be combined with features, aspects, and/or implementations of any of the previous figures or otherwise described herein.

Turning to FIG. 5, block 500 may involve determining a power curve image that includes a plurality of pixels that represents power production by a plurality of wind turbines of a wind farm as a function of wind speed.

Block 502 may involve determining, by an ML encoder model, a latent representation of attributes of the wind farm based on processing the power curve image by the ML encoder model.

Block 504 may involve obtaining an expected weather data corresponding to a future time.

Block 506 may involve determining, based on the latent representation and the expected weather data, an expected power production by the wind farm at the future time.

Block 508 may involve generating an output that includes the expected power production.

In some embodiments, the ML encoder model may have been trained to, and may thus be configured to, determine the attributes of the wind farm based on the power curve image and independently of direct measurements of the attributes of the wind farm.

In some embodiments, the plurality of pixels of the power curve image may represent a graph that indicates, along a first axis thereof, an amount of power produced by the plurality of wind turbines and, along a second axis thereof, the wind speed.

In some embodiments, determining the power curve image may include obtaining a plurality of samples representing the power production by the plurality of wind turbines. Each respective sample of the plurality of samples may represent a corresponding power produced by the plurality of wind turbines at a corresponding wind speed. Determining the power curve image may also include determining a predetermined number of samples corresponding to a sample density based on which the ML encoder model has been trained. Determining the power curve image may further include selecting, from the plurality of samples, the predetermined number of samples, and generating the power curve image based on the predetermined number of selected samples.

In some embodiments, selecting the predetermined number of samples may include determining a minimum wind speed and a maximum wind speed based on which the ML encoder model has been trained, and selecting, from the plurality of samples, the predetermined number of samples such that the corresponding wind speed of each respective selected sample of the predetermined number of selected samples is (i) greater than or equal to the minimum wind speed and (ii) less than or equal to the maximum wind speed.

In some embodiments, generating the power curve image may include determining, for each respective selected sample of the predetermined number of selected samples, a corresponding normalized power production based on (i) the corresponding power produced by the plurality of wind turbines and (ii) a maximum power that the plurality of wind turbines is capable of producing. The power curve image may be generated based on the corresponding normalized power production of each respective selected sample.

In some embodiments, determining the power curve image may include generating a color version of the power curve image, and generating, based on the color version of the power curve image, a grayscale version of the power curve image. The ML encoder model may be configured to process the grayscale version of the power curve image.

In some embodiments, determining the power curve image may include generating a full-resolution version of the power curve image, and generating, based on the full-resolution version of the power curve image, a down-sampled version of the power curve image having a resolution based on which the ML encoder model has been trained. The ML encoder model may be configured to process the down-sampled version of the power curve image.

In some embodiments, generating the down-sampled version of the power curve image may include filtering the down-sampled version of the power curve image using at least one of an erosion operator or a dilation operator to reduce a number of outlier samples represented by the down-sampled version of the power curve image. The down-sampled version of the power curve image may be provided as input to the ML encoder model after the filtering.

In some embodiments, the expected weather data may include an expected wind speed corresponding to the future time.

In some embodiments, determining the expected power production by the wind farm may include determining the expected power production based on processing the latent representation and the expected weather data by a power prediction ML model that has been trained to predict power production of respective wind farms based on corresponding attributes of the respective wind farms as represented by corresponding latent representations.

Turning to FIG. 6, block 600 may involve determining a training power curve image that includes a plurality of pixels that represents power production by a plurality of training wind turbines of a training wind farm as a function of wind speed.

Block 602 may involve determining, by an ML encoder model, a training latent representation of attributes of the training wind farm based on processing the training power curve image by the ML encoder model.

Block 604 may involve determining, by an ML decoder model, a reconstruction of the training power curve image based on processing the training latent representation by the ML decoder model.

Block 606 may involve determining a loss value based on comparing (i) the reconstruction of the training power curve image to (ii) the training power curve image.

Block 608 may involve adjusting one or more parameters of the ML encoder model based on the loss value.

In some embodiments, the plurality of pixels of the training power curve image may represents a graph that indicates, along a first axis thereof, an amount of power produced by the plurality of training wind turbines and, along a second axis thereof, the wind speed.

In some embodiments, determining the training power curve image may include obtaining a plurality of training samples representing the power production by the plurality of training wind turbines. Each respective training sample of the plurality of training samples may represent a corresponding power produced by the plurality of training wind turbines at a corresponding wind speed. Determining the training power curve image may also include determining a predetermined number of training samples corresponding to a sample density selected for training the ML encoder model. Determining the training power curve image may further include selecting, from the plurality of training samples, the predetermined number of training samples, and generating the training power curve image based on the predetermined number of selected training samples.

In some embodiments, selecting the predetermined number of training samples may include determining a minimum wind speed and a maximum wind speed for training the ML encoder model, and selecting, from the plurality of training samples, the predetermined number of training samples such that the corresponding wind speed of each respective selected training sample of the predetermined number of selected training samples is (i) greater than or equal to the minimum wind speed and (ii) less than or equal to the maximum wind speed.

In some embodiments, generating the training power curve image may include determining, for each respective selected training sample of the predetermined number of selected training samples, a corresponding normalized power production based on (i) the corresponding power produced by the plurality of training wind turbines and (ii) a maximum power that the plurality of training wind turbines is capable of producing. The training power curve image may be generated based on the corresponding normalized power production of each respective selected training sample.

In some embodiments, determining the training power curve image may include generating a color version of the training power curve image, and generating, based on the color version of the training power curve image, a grayscale version of the training power curve image. The ML encoder model may be configured to process the grayscale version of the training power curve image.

In some embodiments, determining the training power curve image may include generating a full-resolution version of the training power curve image, and generating, based on the full-resolution version of the training power curve image, a down-sampled version of the training power curve image. The ML encoder model may be configured to process the down-sampled version of the training power curve image.

In some embodiments, generating the down-sampled version of the training power curve image may include filtering the down-sampled version of the training power curve image using at least one of an erosion operator or a dilation operator to reduce a number of outlier samples represented by the down-sampled version of the training power curve image. The down-sampled version of the training power curve image may be provided as input to the ML encoder model after the filtering.

In some embodiments, a power prediction ML model may be trained to determine an expected power production by the training wind farm at a future time based on processing, by the power prediction ML model, the training latent representation and expected weather data corresponding to the future time.

### VI. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A computer-implemented method comprising:
determining a power curve image comprising a plurality of pixels that represents power production by a plurality of wind turbines of a wind farm as a function of wind speed;
determining, by a machine learning (ML) encoder model, a latent representation of attributes of the wind farm based on processing the power curve image by the ML encoder model;
obtaining an expected weather data corresponding to a future time;
determining, based on the latent representation and the expected weather data, an expected power production by the wind farm at the future time; and
generating an output comprising the expected power production.

2. The computer-implemented method of claim 1, wherein the ML encoder model has been trained to determine the attributes of the wind farm based on the power curve image and independently of direct measurements of the attributes of the wind farm.

3. The computer-implemented method of claim 1, wherein the plurality of pixels of the power curve image represents a graph that indicates, along a first axis thereof, an amount of power produced by the plurality of wind turbines and, along a second axis thereof, the wind speed.

4. The computer-implemented method of claim 1, wherein determining the power curve image comprises:
obtaining a plurality of samples representing the power production by the plurality of wind turbines, wherein each respective sample of the plurality of samples represents a corresponding power produced by the plurality of wind turbines at a corresponding wind speed;
determining a predetermined number of samples corresponding to a sample density based on which the ML encoder model has been trained;
selecting, from the plurality of samples, the predetermined number of samples; and
generating the power curve image based on the predetermined number of selected samples.

5. The computer-implemented method of claim 4, wherein selecting the predetermined number of samples comprises:
determining a minimum wind speed and a maximum wind speed based on which the ML encoder model has been trained; and
selecting, from the plurality of samples, the predetermined number of samples such that the corresponding wind speed of each respective selected sample of the predetermined number of selected samples is (i) greater than or equal to the minimum wind speed and (ii) less than or equal to the maximum wind speed.

6. The computer-implemented method of claim 4, wherein generating the power curve image comprises:
determining, for each respective selected sample of the predetermined number of selected samples, a corresponding normalized power production based on (i) the corresponding power produced by the plurality of wind turbines and (ii) a maximum power that the plurality of wind turbines is capable of producing; and
generating the power curve image based on the corresponding normalized power production of each respective selected sample.

7. The computer-implemented method of claim 1, wherein determining the power curve image comprises:
generating a color version of the power curve image; and
generating, based on the color version of the power curve image, a grayscale version of the power curve image, wherein the ML encoder model is configured to process the grayscale version of the power curve image.

8. The computer-implemented method of claim 1, wherein determining the power curve image comprises:
generating a full-resolution version of the power curve image; and
generating, based on the full-resolution version of the power curve image, a down-sampled version of the power curve image having a resolution based on which the ML encoder model has been trained, wherein the ML encoder model is configured to process the down-sampled version of the power curve image.

9. The computer-implemented method of claim 8, wherein generating the down-sampled version of the power curve image comprises:
filtering the down-sampled version of the power curve image using at least one of an erosion operator or a dilation operator to reduce a number of outlier samples represented by the down-sampled version of the power curve image, wherein the down-sampled version of the power curve image is provided as input to the ML encoder model after the filtering.

10. The computer-implemented method of claim 1, wherein the expected weather data comprises an expected wind speed corresponding to the future time.

11. The computer-implemented method of claim 1, wherein determining the expected power production by the wind farm comprises:
determining the expected power production based on processing the latent representation and the expected weather data by a power prediction ML model that has been trained to predict power production of respective wind farms based on corresponding attributes of the respective wind farms as represented by corresponding latent representations.

12. A computer-implemented method, comprising:
determining a training power curve image comprising a plurality of pixels that represents power production by a plurality of training wind turbines of a training wind farm as a function of wind speed;
determining, by a machine learning (ML) encoder model, a training latent representation of attributes of the training wind farm based on processing the training power curve image by the ML encoder model;
determining, by an ML decoder model, a reconstruction of the training power curve image based on processing the training latent representation by the ML decoder model;
determining a loss value based on comparing (i) the reconstruction of the training power curve image to (ii) the training power curve image; and
adjusting one or more parameters of the ML encoder model based on the loss value.

13. The computer-implemented method of claim 12, wherein the plurality of pixels of the training power curve image represents a graph that indicates, along a first axis thereof, an amount of power produced by the plurality of training wind turbines and, along a second axis thereof, the wind speed.

14. The computer-implemented method of claim 12, wherein determining the training power curve image comprises:
obtaining a plurality of training samples representing the power production by the plurality of training wind turbines, wherein each respective training sample of the plurality of training samples represents a corresponding power produced by the plurality of training wind turbines at a corresponding wind speed;
determining a predetermined number of training samples corresponding to a sample density selected for training the ML encoder model;
selecting, from the plurality of training samples, the predetermined number of training samples; and
generating the training power curve image based on the predetermined number of selected training samples.

15. The computer-implemented method of claim 14, wherein selecting the predetermined number of training samples comprises:
determining a minimum wind speed and a maximum wind speed for training the ML encoder model; and
selecting, from the plurality of training samples, the predetermined number of training samples such that the corresponding wind speed of each respective selected training sample of the predetermined number of selected training samples is (i) greater than or equal to the minimum wind speed and (ii) less than or equal to the maximum wind speed.

16. The computer-implemented method of claim 14, wherein generating the training power curve image comprises:
determining, for each respective selected training sample of the predetermined number of selected training samples, a corresponding normalized power production based on (i) the corresponding power produced by the plurality of training wind turbines and (ii) a maximum power that the plurality of training wind turbines is capable of producing; and
generating the training power curve image based on the corresponding normalized power production of each respective selected training sample.

17. The computer-implemented method of claim 12, wherein determining the training power curve image comprises:
generating a full-resolution version of the training power curve image; and
generating, based on the full-resolution version of the training power curve image, a down-sampled version of the training power curve image, wherein the ML encoder model is configured to process the down-sampled version of the training power curve image.

18. The computer-implemented method of claim 12, further comprising:
training a power prediction ML model to determine an expected power production by the training wind farm at a future time based on processing, by the power prediction ML model, the training latent representation and expected weather data corresponding to the future time.

19. A system comprising:
a processor; and
a non-transitory computer-readable medium having stored thereon instructions that, when executed by the processor, cause the processor to perform operations comprising:
determining a power curve image comprising a plurality of pixels that represents power production by a plurality of wind turbines of a wind farm as a function of wind speed;
determining, by a machine learning (ML) encoder model, a latent representation of attributes of the wind farm based on processing the power curve image by the ML encoder model;
obtaining an expected weather data corresponding to a future time;
determining, based on the latent representation and the expected weather data, an expected power production by the wind farm at the future time; and
generating an output comprising the expected power production.

20. The system of claim 19, wherein the plurality of pixels of the power curve image represents a graph that indicates, along a first axis thereof, an amount of power produced by the plurality of wind turbines and, along a second axis thereof, the wind speed.
